(19) United States
(12) Patent Application Publication
(10) Pub. No.: US 2005/0227734 A1
(43) Pub. Date: Oct. 13, 2005

(54) Method for the reduction of radiation in a radio telecommunication system, together with associated base station and associated mobile terminal device

(76) Inventor: Christoph Euscher, Rhede (DE)

Correspondence Address: BELL, BOYD & LLOYD, LLC, P. O. BOX 1135, CHICAGO, IL, 60690-1135, US

(21) Appl. No.: 10/514,228

(22) PCT Filed: Apr. 2, 2004
(86) PCT No.: PCT/EP04/05022

§ 371 Date: Nov. 12, 2004

(51) Int. Cl. H04Q 7/20

(52) U.S. Cl. 455/561; 455/435.1

(57) ABSTRACT

Method for the reduction of radiation in a radio telecommunication system, together with associated base station and associated mobile terminal device.

The present invention relates to a method for the reduction of radiation in a radio telecommunication system which radiates at least a radio synchronization signal for the purpose of synchronizing a base station with at least one mobile terminal device, in which initially the number of mobile terminal devices registered with the base station is detected (S1), after which the number of virtual continuous receive status flags is set (S2) and finally a comparison is made between the number of registered terminal devices and the number of virtual continuous receive status flags (S3), whereby the base station is switched into a quiescent operating state (S4) if the comparison determines that these numbers are the same, and otherwise the base station remains in a normal operating state (S5). In this way it is possible to significantly reduce the radiation generated in the telecommunication system.

### BACKGROUND OF THE INVENTION

The present invention relates to a method for the reduction of radiation in a radio telecommunication system, together with an associated base station and an associated mobile terminal device and, in particular, to a DECT telecommunication system with reduced radiation.

Publication DE 199 27 585 A1 discloses a radio telecommunication system in which, to reduce radiation, the base station is set into a quiescent operating state, in which status no radio synchronization signal is emitted if a sensor detects that a mobile terminal device is present in the base station, whereby it swaps immediately from the quiescent operating state into a normal operating state as soon as an external call arrives. In this way, the radio synchronization signal required for synchronization between the base station and the mobile terminal device can be kept to a minimal magnitude, which reduces the radiation or so-called “electrosmog.” However, a disadvantage of this is that a system of this type is only suitable for telecommunication systems which have exactly one base station and one mobile terminal device.

In principle, however, numerous mobile terminal devices can be registered and operated in radio telecommunication systems of this type, in which the additional mobile terminal devices normally have only a charging cradle, and can be registered with a telecommunication system which already exists or a base station which is already present, as applicable.

The present invention, is therefore seeks to devise an improved method for reducing radiation in a radio telecommunication system, together with an associated base station and an associated mobile terminal device.

### SUMMARY OF THE INVENTION

In particular, by detecting the number of mobile terminal devices registered with the base station, by setting or defining, as appropriate, a number of virtual continuous receive status flags, which signal an actual or apparent continuous receive state for the mobile terminal devices, and by a comparison of the number of registered terminal devices with the number of virtual continuous receive status flags, whereby if this comparison determines that the numbers are the same, the base station is switched into a quiescent operating state. In this quiescent operating state not even the radio synchronization signal is transmitted, and otherwise the base station remains in a normal operating state, in which at least the radio synchronization signal is emitted, whereby it is possible to achieve a reliable reduction in the radiation or “electrosmog,” as applicable, as a function of the relevant state data, without restricting the functionality.

The virtual continuous receive status flags preferably are defined or set, as applicable, by each registered mobile terminal device as a function of its energy supply. In this way, for example, it only will be possible for the virtual continuous receive status flag concerned to be sent out, and the terminal device be put into an energy-intensive actual continuous receive state, when the mobile terminal device is deposited in a charging cradle. As soon as all the mobile terminal devices signal a state of this type, the associated base station can then switch off the radio synchronization signal, which normally is always required, as a result of which one achieves total radio silence in the radio telecommunication system.

It is possible, in addition, for the continuous receive status flags to be defined as functions of a user input, and independently of any actual state of the mobile terminal devices, which makes it possible to achieve reduced radiation in the radio telecommunication system without regard for the energy consumption concerned in the mobile terminal device.

Furthermore, the virtual continuous receive status flags also can be defined to depend on a timing unit so that the status flags are set, for example, as a function of the time of day such that absolute radio silence or a reduction in the radiation, as applicable, sets in for the telecommunication system.

Although an actual state of the mobile terminal devices is not, in principle, defined by the virtual continuous receive status flags which are specified or set, this actual state also can, of course, be activated as a function of the specification of the virtual continuous receive status flag. In this way, for example, a base station can also specify an actual or apparent continuous receive state for a mobile terminal device by remote control.

Although the user input and the timing unit preferably are located at the base station end, it is also possible to locate an appropriate input and/or timing unit in one of the mobile terminal devices.

Furthermore, the operating state of the base station can be displayed on the mobile terminal devices and/or on the base station whereby, for example, radio silence can be indicated and, if the indication is not showing, any mobile terminal device which is causing this can, for example, be reset to an appropriate state.

In the quiescent operating state the receiver in the base station preferably is switched to continuous receive, from which quiescent operating state a normal operating state can be activated via a connection request from the terminal device end by the mobile terminal devices. In addition, this activation of the normal operating state can, of course, be effected via a connection request from the exchange end.

Preferably, synchronization of the base station with the mobile terminal devices will be effected in the quiescent operating state via a wire-conducted synchronization signal, such as, for example, the mains supply frequency of a shared mains power supply, by which the power consumption can be further reduced and connection setup speeded up.

Although the virtual status flags are preferably transmitted between the base station and the mobile terminal devices via the radio interface of the telecommunication system, there may, in addition, be a supplementary interface between the base station and the mobile terminal devices which enables the status flags to be transmitted via this supplementary interface. In this way, it is possible to transmit the appropriate flag using infrared, Bluetooth, Powerline, etc.

For the purpose of further reducing the activation time, it is also possible to transmit the radio synchronization signal on the last-used frequency, after the normal operating state has been activated.

With respect to the base station, use preferably made of a transmit unit for transmitting at least one radio synchronization signal, a receive unit for receiving data at the radio interface, and a control unit for controlling the transmit and receive unit, whereby a memory unit will store the number of mobile terminal devices registered with the base station plus the number of virtual continuous receive status flags. The control unit sets the base station into a quiescent operating state, in which not even the radio synchronization signal is transmitted, if an evaluation by the memory unit determines that the number of registered terminal devices is equal to the number of virtual continuous receive status flags. In this way, one obtains a base station which, even when it is administering at least one registered mobile terminal device, can conditionally reduce its radiation.

With respect to the mobile terminal device, use preferably is made of a transmit unit for transmitting data, a receive unit for receiving data, and a control unit for controlling the transmit and receive units, whereby a status flag determination unit specifies or sets, as appropriate, a virtual continuous receive status flag, and when there is a virtual continuous receive status flag the control unit transmits this via the transmit unit and switches the receive unit over to actual continuous receive, or into a state of readiness for such. Since the receive unit is then in a continuous receive operating mode, the radio synchronization signal in the telecommunication system can be switched off, with complete radio silence being effected, in which the actual continuous receive readiness of the mobile terminal devices allows it to remain possible to activate them. As this continuous receive readiness generally has a high energy requirement, the setting of such a virtual continuous receive status flag generally will be dependent on an energy supply and, in particular, on the connection of an external energy supply.

Additional features and advantages of the present invention are described, and will be apparent from, the following Detailed Description of the Invention and the Figures.

### BRIEF DESCRIPTION OF THE FIGURES

FIG. 1 shows a simplified flow diagram to illustrate the steps in the method for the reduction of radiation in a radio telecommunication system in accordance with the present invention.

FIG. 2 shows a simplified block diagram of the radio telecommunication system in accordance with the present invention.

FIG. 3 shows a simplified block diagram of a mobile terminal device for the radio telecommunication system in accordance with FIG. 2.

### DETAILED DESCRIPTION OF THE INVENTION

The present invention is described below by reference to a radio telecommunication system conforming to the DECT standard.

In a DECT telecommunication system of this type, one or more mobile terminal devices, such as cordless or wireless telephones, can be operated through one or more base stations. In this situation, at least one channel is made available to the one or more mobile terminal devices which are registered, whereby, for example, data transmission and, in particular, the transmission of voice data, is made possible.

To enable a mobile terminal device to communicate with the base station and, for example, to transmit a directory number in order to initiate a call, requires a radio synchronization signal or a so-called (dummy) bearer, as applicable. In a normal operating state, in which at least the radio synchronization signal is transmitted, there is, consequently, a certain radiation in the telecommunication system, even though no actual data transmission is taking place between the base station and the mobile terminal devices.

For the purpose of reducing this minimum radiation or the radio synchronization signal, as applicable, the following method is therefore proposed.

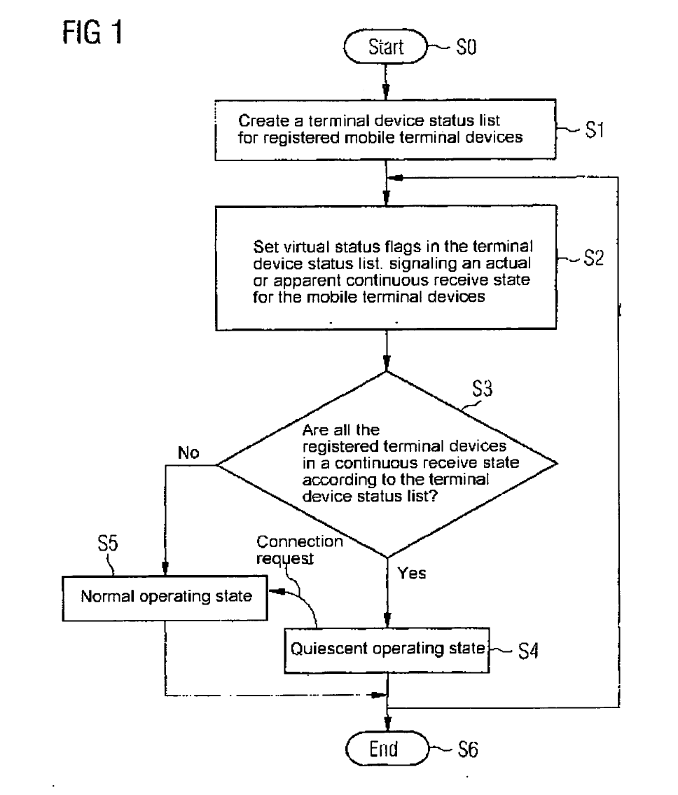

FIG. 1 shows a simplified representation of a flow diagram to illustrate the steps in a method for reducing radiation in a radio telecommunication system (such as, for example, a DECT system), which radiates at least a radio synchronization signal, such as a (dummy) bearer, for the purpose of synchronizing a base station with at least one mobile terminal device.

After the start in step S0, step S1 starts with a determination of the number of mobile terminal devices registered with the base station. In what follows, the term registration with a base station will be understood as referring to both a short-term association with the base station, such as, for example, in WLAN systems (Wireless Local Area Network), and a long-term entry (subscription), such as, for example, in DECT systems (Digital European Cordless Communication).

Preferably, this will involve the setting up of a terminal device status list for all the registered mobile terminal devices, into which various items of state data can be entered and, in particular, a so-called virtual continuous receive state or a virtual continuous receive status flag, as applicable, indicating or signaling, as appropriate, either an actual continuous receive state or an apparent continuous receive state. In particular, in the apparent continuous receive state, the terminal device is not really in a continuous receive state, but only simulates this or is in a preparatory state of readiness.

In a step S2 which follows, a number of virtual continuous receive status flags are specified or set, as applicable, indicating or signaling, as appropriate, the actual or apparent continuous receive state of the mobile terminal device concerned. After this specification or setting, as applicable, of the virtual continuous receive status flags in the terminal device status list as shown in step S2, a comparison is made in step S3 between the number of registered terminal devices and the number of virtual continuous receive status flags. More precisely stated, a check is made as to whether, according to the terminal device status list, all the registered terminal devices have signaled an actual or apparent continuous receive state, or are ready to swap into a continuous receive state and are thus only waiting, for example, for a wake-up signal.

If it is found, when this comparison is made in accordance with step S3, that the number of registered terminal devices and the number of virtual continuous receive status flags are the same (and, hence, for example, that all the registered terminal devices are actually in a continuous receive state), then in a step S4 the base station can be switched into a quiescent operating state in which even the radio synchronization signal or the (dummy) bearer, as applicable, is no longer transmitted. If it is found, when the check is carried out as in step S3, that the numbers do not agree, or according to the terminal device status list not all the mobile terminal devices are in a continuous receive state, then as shown in step S5 the base station will remain in its normal operating state, in which at least the radio synchronization signal continues to be transmitted and furthermore, a data transmission can take place. The program ends in a step S6, preferably with the possibility after step S4 or S5, as applicable, of branching back to before step S2, to permit a cyclic specification or setting, as appropriate, of the virtual status flags and their subsequent checking.

In this way, it is possible for the (dummy) bearer, transmitted, for example, in DECT systems in regular cycles (e.g., 160 ms), to be switched off so that, although the current demand in the mobile terminal devices is increased due to their continuous receive state, the radiation in the radio telecommunication system is nevertheless reliably reduced.

As shown in FIG. 1, the specification of the continuous receive status flags in step S2 is preferably made by a mobile terminal device which is registered or associated, as applicable, with the specification of the virtual continuous receive status flags preferably being dependent on an energy supply, and, in particular, on a battery charging current. In this manner, the energy requirement in the mobile terminal devices, which is raised in an actual continuous receive state, results in absolutely no problems, so that the stand-by times of the mobile terminal devices remain unchanged.

In addition to the above, the virtual continuous receive status flags, set or specified as applicable as shown in S2, also could be set or specified depending on a user input, either directly at the base station or indirectly via the mobile terminal devices or their associated charging cradles, as applicable, by which one achieves a flexible ability to make settings for the telecommunication system and, for example, even older mobile terminal devices (i.e., earlier product generations) can be integrated into such a telecommunication system, without detriment to the ability to achieve a radio silence. Particularly with such terminal devices, the virtual continuous receive status flags will be specified in the base station, independently of any actual continuous receive state of the terminal device.

Although it follows that normally any actual state of the mobile terminal devices will correspond to the specified continuous receive status flag, it also follows that such a state can be assigned to the mobile terminal devices even if they do not have such a functionality. Consequently, allowance must be made for certain functional shortcomings.

In this connection, when specifying the virtual continuous receive status flags, for example, even a base station can specify centrally an actual state for a mobile terminal device, resulting in a simplification of the operating capability.

Although the specification of the virtual continuous receive status flags in step S2 preferably depend on an energy supply to the mobile terminal device, or on a user input, it is possible for the specification of these virtual continuous receive status flags also to be made dependent on a timing unit. Here, the timing unit can be located either in the base station or equally well in a mobile terminal device or an associated charging cradle. In this way, it is possible, particularly with programmable timing units, to achieve so-called day and night radio silences, according to which, for example, an “unconditional” radio silence can be set during the night.

In addition, both the base station and the mobile terminal devices can have a facility for displaying the operating states shown in steps S4 and S5, by which the current state of the radiation in the telecommunication system can be indicated to a user visually, audibly or in some other form.

If the base station is in a quiescent operating state as in step S4, then a receiver in the base station is preferably switched over to continuous receive in order, for example, to detect a connection request from the terminal device side (i.e., a connection request from the mobile terminal devices), and thereupon to switch into a normal operating state. On the other hand, this transition from the quiescent operating state in step S4 to the normal operating state as in step S5 also may be effected by a connection request from the switching center side, whereby, for example, a call from the exchange side requires the establishment of a data transmission channel to a mobile terminal device.

For the purpose of reducing the energy requirement, due particularly to the continuous receive state in the base station and the mobile terminal devices while in the quiescent operating state in S4, it is possible in this step for synchronization of the base station with the numerous mobile terminal devices also to be effected via of a wire-bound synchronization signal, whereby the alternating current frequency of a mains power supply can provide an appropriate synchronization signal and the “continuous receive periods” of the receive units can be correspondingly reduced to reduce the energy requirements. Insofar as this means that all the mobile terminal devices can derive an appropriate wire-bound synchronization signal, such as via a charging cradle, the radio signal also can generally be switched off. In this way, it is possible, in particular, to speed up significantly the establishment of a connection between the mobile terminal devices and the base station.

Although the steps S1 to S3 are usually performed directly in the base station, and only step S2 is performed in the mobile terminal devices, and use is made of the radio interface to transmit the specified status flags, it is possible to implement, in addition to the radio interface which is available, a supplementary interface in the form of a Bluetooth, infrared or Powerline interface, for example, for transmitting the status flags from the mobile terminal devices or the associated charging cradles, as appropriate, to the base station.

In particular, when the transition is made from the quiescent operating state as in step S4 into the normal operating state as in step S5 due to a connection request, the radio synchronization signal initially can be transmitted on the last-used frequency, whereby a connection setup is further speeded up.

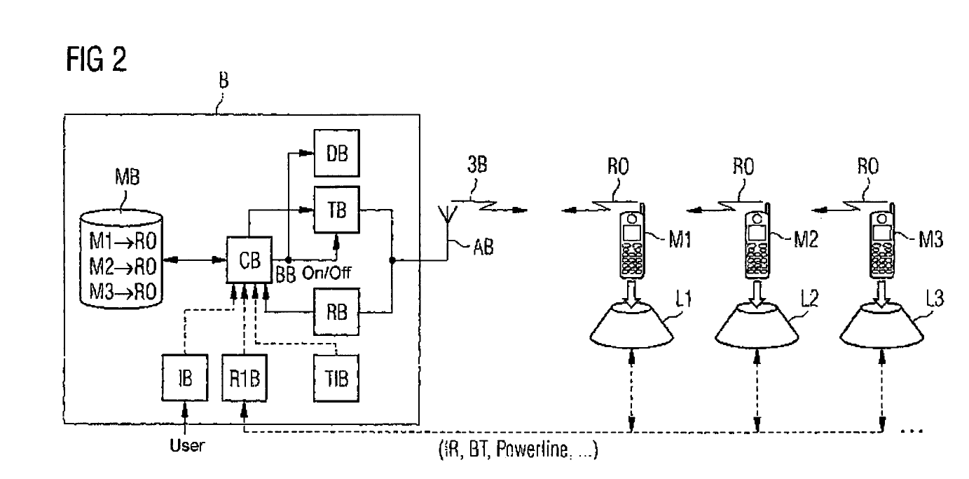

FIG. 2 shows a simplified block diagram to illustrate a radio telecommunication network system such as that provided, for example, by the DECT standard.

As shown in FIG. 2, numerous mobile terminal devices M1, M2 and M3 are registered with a base station B, each of which has, for example, a charging cradle L1 to L3. In a normal operating state, the antenna AB on the base station B transmits at regular intervals the so-called (dummy) bearer BB as the radio synchronization signal, which makes it possible for the mobile terminal devices M1 to M3 to switch on their receivers in a current-saving way, for brief periods only and on a synchronous cycle, in order to obtain the current system states such as, for example, incoming calls.

In this connection, the base station B has a transmit unit TB for the purpose of sending at least the radio synchronization signal BB via the DECT radio interface, with a receive unit RB which receives any data on this radio interface. A control unit CB controls the main aspects of the procedures in the base station B and, in particular, the transmit and receive units TB and RB.

For the purpose of achieving the “radio silence capability” described above, the base station B additionally includes a memory unit MB for saving the number of mobile terminal devices M1 to M3 registered with the base station, plus the number of virtual continuous receive status flags RO (Receiver Open) which indicate or signal, as appropriate, an actual or apparent continuous receive state for the mobile terminal devices. Here, the control unit CB evaluates the memory unit MB in respect of the number of terminal devices registered and the number of virtual continuous receive status flags present, with the objective that if the number of registered terminal devices and the number of continuous receive status flags are the same, the base station B will be switched into a quiescent operating state, in which even the radio synchronization signal BB will no longer be transmitted. For example, the control unit CB may directly switch the transmit unit TB so that the transmit unit prevents any transmission of data.

In this way, it is possible to prevent radiation in the telecommunication system and, in particular, the emission of the radio synchronization signal or the (dummy) bearer BB, whenever all the mobile terminal devices are placed back in their charging cradles L1 to L3, for example, with the implication that no communication takes place. In this case, each of the mobile terminal devices M1 to M3 generates a virtual continuous receive status flag RO in each case, which is preferably communicated via the DECT radio interface to the base station B, and is stored therein in the memory MB. As soon as the number of registered mobile terminal devices agrees with the number of continuous receive status flags entered, the base station assumes that all the mobile terminal devices have been placed in their charging cradles, and an appropriate energy-intensive continuous receive state has been activated, and therefore switches off the radio synchronization signal BB from this point on.

Although it follows that the virtual continuous receive status flags RO are preferably specified and transmitted to the base station by the mobile terminal devices M1 to M3 or their associated charging cradles L1 to L3, as applicable, the base station B also may have a user input unit IB with which the user can input the virtual continuous receive status flag RO, which may depend on or be independent of any actual state of the associated mobile terminal device. To be more precise, it follows that a user can also input or modify, as appropriate, the assignment of the registered terminal devices, preferably held as a status list in the memory unit MB, and their virtual continuous receive status flags. In particular, when use is being made of mobile terminal devices, or their associated charging cradles, which are old or incompatible with the system, it follows that such devices can be preset by the user, via which it is possible to ensure the continuing basic functionality of the system.

In addition, the base station B may include a timing unit TI, with which a predefined virtual continuous receive status flag is generated depending, for example, on the time of day. Preferably, this timing unit will, in addition, be programmable by a user, via which one can define certain times of day, such as, for example, the night, as a time of radio silence.

In addition to the above, the base station B may include a display unit DB for displaying the relevant operating state of the base station, enabling a user at any time to distinguish a normal operating state from a quiescent operating state and, in particular, terminal devices which are not in the continuous receive state can be detected.

Although the virtual continuous receive status flag RO will preferably will be transmitted via the radio interface which is available, the base station can, in addition have a supplementary receive unit RIB, which enables the status flags to be received via, for example, an infrared interface IR, a Bluetooth interface BT or a Powerline interface.

In addition, it also is possible via the infrared interface IR to derive a mains power supply frequency (50 Hz), using which it is possible to achieve synchronization of the base station B with the numerous mobile terminal devices M1 to M3 via a wire-bound synchronization signal.

For the purpose of reactivating a normal operating state via the prescribed radio interface, the control unit CB can switch the receive unit RB in the base station, when in the quiescent operating state, to continuous receive so that a connection request on the mobile terminal device side or terminal device side, as applicable, then can be made, for example, via a MAC setup signal (MAC, Media Access Control).

In the same way, there is also the possibility of the control unit CB switching the base station into a normal operating state, in which at least the radio synchronization signal or the (dummy) bearer BB, as applicable, is transmitted if a connection request is present from the switching center side.

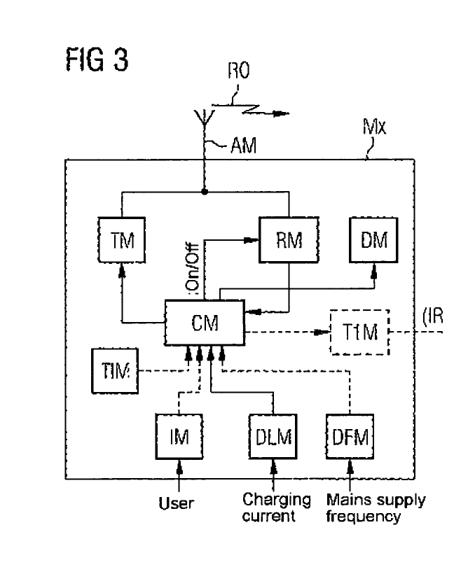

FIG. 3 shows a simplified block diagram of a mobile terminal device in the telecommunication system as shown in FIG. 2, in which the same reference characters refer to elements which are the same or correspond, and for which the descriptions are not repeated below.

As shown in FIG. 3, a mobile terminal device Mx in accordance with the present invention has a transmit unit TM for sending data at a radio interface and a receive unit RM for receiving data at the radio interface, whereby a control unit CM controls the transmit and receive units together with the functions of the mobile terminal device Mx. For the purpose of specifying a virtual continuous receive status flag RO, the mobile terminal device has a status flag determination unit which can, for example, have a user input unit IM, an energy sensing unit DLM and/or a timing unit TIM. If a specified virtual continuous receive status flag is present or detected by the control unit CM, this virtual continuous receive status flag RO is transmitted via the transmit unit TM or an associated antenna AM, as applicable, and the receive unit RM will, for example, be put into an actual continuous receive state.

Since a continuous receive state of this type in the mobile terminal device implies a raised energy requirement, the status flag specification unit preferably includes an energy supply detection unit DLM, which only generates or specifies, as applicable, a virtual continuous receive status flag if the energy supply is being provided from an external energy supply. For example, for this purpose the charging current for a battery or energy storage unit, as applicable, not shown here may be analyzed for this purpose, from which it is possible to determine that, for example, a mobile terminal device is sitting in a charging cradle and is being powered from an external power supply.

Analogous to the base station, the mobile terminal device also may include a user input unit IM, which specifies a virtual continuous receive status flag RO depending on the user input concerned. Mobile terminal devices also may be operated in this way even if they are not sitting in a charging cradle, subject to the risk of rapid discharge but to the benefit of radio silence.

Analogous again to the base station, the mobile terminal device also may include a timing unit TIM as a status flag determination unit, whereby a continuous receive status flag RO can be specified depending on a time of day.

In the same way as the base station, the mobile terminal device also may include a display unit DM for displaying the operating state of the base station or the telecommunication system, as appropriate, in which, for example, an LED, a pictogram or any other indicating device can be used.

For the purpose of achieving an alternative synchronization between the base station B and the mobile terminal devices Mx, using a wire-bound synchronization signal, the mobile terminal device Mx also may include a supplementary synchronization unit DFM which, for example, by making use of a power supply frequency from the available mains power supply, enables synchronization in the quiescent operating state, by which it is possible both to reduce the energy requirements and to speed up the establishment of a connection.

Further, the mobile terminal device may include a supplementary transmit unit TIM for effecting a supplementary interface such as, for example, an IR (infrared), BT (Bluetooth), Powerline interface etc., in order to transmit any virtual continuous receive status flags RO which are specified or set, as applicable, to the base station B via this supplementary transmit unit.

The present invention has been described above by reference to a DECT telecommunication system. However, the present invention is not restricted to this system, and covers in a similar way alternative telecommunication systems, such as WLAN, HYPERLAN, Bluetooth, etc., which have a so-called radio synchronization signal for the purpose of synchronizing a base station with its associated terminal devices.

Further, in accordance with the above description there are numerous elements integrated directly into the mobile terminal device. However, particularly in the case of mobile terminal devices used with associated charging cradles, many of the units such as, for example, an energy sensing unit, a user input unit, a timing unit, a supplementary interface and a supplementary synchronization unit, can be incorporated directly in the charging cradle.

Although the present invention has been described with reference to specific embodiments, those of skill in the art will recognize the changes may be made thereto without departing from the spirit and scope of the present invention as set forth in the hereafter appended claims.

1-30. (canceled)

31. A method for reducing radiation in a radio telecommunication system which radiates at least one radio synchronization signal for synchronizing a base station with at least one mobile terminal device, the method comprising:
detecting a number of mobile terminal devices registered at the base station;
setting a number of virtual continuous receive status flags, which signal one of an actual and an apparent continuous receive state for the mobile terminal devices; and
comparing a number of registered mobile terminal devices with the number of virtual continuous receive status flags, wherein the base station is switched into a quiescent operating state, in which the radio synchronization signal is not transmitted, if the comparison determines that the numbers of registered mobile terminal devices is the same as the number of virtual continuous receive status flags, and if the number of registered mobile terminal devices is not the same as the number of virtual continuous receive status flags, the base station remains in a normal operating state, in which at least the radio synchronization signal is transmitted.

32. A method for reducing radiation in a radio telecommunication system as claimed in claim 31, wherein in the step of setting, a registered mobile terminal device sets its respective virtual continuous receive status flag.

33. A method for reducing radiation in a radio telecommunication system as claimed in claim 32, wherein the setting of a virtual continuous receive status flag is dependent on an energy supply of the respective mobile terminal device.

34. A method for reducing radiation in a radio telecommunication system as claimed in claim 32, wherein the setting of a virtual continuous receive status flag is dependent on a user input.

35. A method for reducing radiation in a radio telecommunication system as claimed in claim 32, wherein activation of an actual state of a respective mobile terminal device is dependent on the respective virtual continuous receive status flag set.

36. A method for reducing radiation in a radio telecommunication system as claimed in claim 31, wherein in the step of setting, the base station sets a virtual continuous receive status flag for a mobile terminal device.

37. A method for reducing radiation in a radio telecommunication system as claimed in claim 36, wherein the setting of a respective virtual continuous receive status flag is dependent on a user input.

38. A method for reducing radiation in a radio telecommunication system as claimed in claim 31, wherein the setting of a respective virtual continuous receive status flag is dependent on a timing unit.

39. A method for reducing radiation in a radio telecommunication system as claimed in claim 31, wherein in the step of comparing, an operating state of the base station is displayed on at least one of the mobile terminal devices and the base station.

40. A method for reducing radiation in a radio telecommunication system as claimed in claim 31, wherein in the step of comparing, when the base station is in the quiescent operating state, a receiver of the base station is switched to continuous receive.

41. A method for reducing radiation in a radio telecommunication system as claimed in claim 31, further comprising activating the normal operating state from the quiescent operating state if the base station receives a connection request on at least one of a switching center side and a mobile terminal device.

42. A method for reducing radiation in a radio telecommunication system as claimed in claim 41, wherein in the step of activating, after activation of the normal operating state, the radio synchronization signal is transmitted on a last-used frequency.

43. A method for reducing radiation in a radio telecommunication system as claimed in claim 31, wherein in the quiescent operating state a wire-bound synchronization signal is used to effect synchronization of the base station with the at least one mobile terminal device.

44. A method for reducing radiation in a radio telecommunication as claimed in claim 38, wherein the steps of detecting and setting are performed in the base station and the step of setting is performed in the at least one terminal device, and wherein the virtual continuance receives status flags are transmitted via one of the radio interface of the telecommunication system and a supplementary interface to the base station.

45. A base station for reducing radiation in a radio telecommunication network, comprising:
a transmit unit for transmitting at least a radio synchronization signal on a radio interface;
a receive unit for receiving data on the radio interface;
a control unit for controlling the transmit unit and the receive unit; and
a memory unit for saving a number of mobile terminal devices registered on the base station and a number of virtual continuance receive status flags which signal one of an actual and an apparent virtual continuance receive state for the mobile terminal devices;
wherein the control unit prompts the base station in the quiescent operating state in which the radio synchronization signal is not transmitted if, according to an analysis of the memory unit by the control unit, a number of registered mobile terminal devices is the same of as a number of virtual continuance received status flags.

46. A base station for reducing radiation in a radio telecommunication network as claimed in claim 45, wherein a respected virtual continuance receive status flag is set by a respective mobile terminal device and received via the receive unit.

47. A base station for reducing radiation in a radio telecommunication network as claimed in claim 45, further comprising a supplementary receive unit, wherein a respective virtual continuance receive status flag is set by a respective mobile terminal device and received via the supplementary receive unit.

48. A base station for reducing radiation in a radio telecommunication network as claimed in claim 45, further comprising a user input unit, wherein a respective virtual continuance receive status flag may be input by a user at least one of depending on and independently of any actual state of the respective mobile terminal device.

49. A base station for reducing radiation in a radio telecommunication network as claimed in claim 45, further comprising a timing unit, wherein a prescribed virtual continuance receive status flag may be set as a function of a time of day.

50. A base station for reducing radiation in a radio telecommunication network as claimed in claim 45, further comprising a display unit for displaying the operating state of the base station.

51. A base station for reducing radiation in a radio telecommunication network as claimed in claim 45, wherein the control switches the receive unit in the quiescent operating state to continuous receive.

52. A base station for reducing radiation in a radio telecommunication network as claimed in claim 45, wherein the control unit switches the base station into a normal operating state in which at least the radio synchronization signal is transmitted if there is a connection request on at least one of a switching center side and a mobile terminal device side.

53. A base station for reducing radiation in a radio telecommunication network as claimed in claim 45, further comprising a supplementary synchronization unit, wherein synchronization of the base station with a plurality of mobile terminal devices is effected via a wire-bound synchronization signal.

54. A mobile terminal device for reducing radiation in a radio telecommunication network, comprising:
a transmit unit for sending data on a radio interface;
a receive unit for receiving data on the radio interface;
a control unit for controlling the transmit unit and the receive unit; and
a status flag determination unit for setting a virtual continuance receive status flag, wherein the control unit, when a virtual continuance receive status flag is set, transmits the virtual continuance receive status flag via the transmit unit and switches the receive unit to one of an actual continuance receive state and a readiness state.

55. A mobile terminal device for reducing radiation in a radio telecommunication network as claimed in claim 54, wherein the status flag determination unit includes an energy supply detection unit which sets a virtual continuance receive status flag if an energy supply for a respective terminal device is being provided from an external supply.

56. A mobile terminal device for reducing radiation in a radio telecommunication network as claimed in claim 54, wherein the status flag determination unit includes a user input unit which specifies the virtual continuance receive status flag depending on a user input.

57. A mobile terminal device for reducing radiation in a radio telecommunication network as claimed in claim 54, wherein the status flag determination unit includes a timing unit which specifies the virtual continuance receive status flag depending on a time of day.

58. A mobile terminal device for reducing radiation in a radio telecommunication network as claimed in claim 54, further comprising a display unit for displaying the operating state of the base station.

59. A mobile terminal device for reducing radiation in a radio telecommunication network as claimed in claim 54, further comprising a supplementary synchronization unit, wherein synchronization of a respective mobile terminal device with the base station is effected via a wire-bound synchronization signal.

60. A mobile terminal device for reducing radiation in a radio telecommunication network as claimed in claim 54, further comprising a supplementary transmit unit, wherein the virtual continuance receive status flag which is set is transmitted to the base station via the supplementary transmit unit.
